(19) United States
(12) Patent Application Publication
(10) Pub. No.: US 2009/0277350 A1
(43) Pub. Date: Nov. 12, 2009

(54) Web-Fed Printing Press

(75) Inventors: Klaus T. Reichel, Augsburg (DE); Georg Schmid, Neusaess (DE)

Correspondence Address: COHEN, PONTANI, LIEBERMAN & PAVANE LLP, 551 FIFTH AVENUE, SUITE 1210, NEW YORK, NY, 10176, US

(73) Assignee: manroland AG, Offenbach am Main (DE)

(21) Appl. No.: 12/434,055

(22) Filed: May 1, 2009

(30) Foreign Application Priority Data
May 8, 2008 (DE) 10 2008 022 635.1

(51) Int. Cl. B41F 31/00

(52) U.S. Cl. 101/351.7

(57) ABSTRACT

A web-fed printing press, wherein the printing couple or each printing couple comprises a form cylinder, a transfer cylinder (10), an inking couple, and preferably a dampening unit, wherein a transfer system is assigned to the transfer cylinder and a printing form system is assigned to the form cylinder, and wherein the transfer system (11) and/or the printing form system includes plural rubber sleeves (13, 14) positioned in the axial direction on the transfer cylinder and/or the printing form system includes plural form sleeves positioned in the axial direction on the form cylinder. The transfer cylinder (10) and/or the form cylinder have at least three independent compressed air systems (19, 20, 21) for installing the rubber sleeves (13, 14) and/or the printing form sleeves, on the respective transfer cylinder and/or the form cylinder, and also to remove the sleeves from the respective cylinder.

### BACKGROUND OF THE INVENTION

1. Field of the Invention

The present invention generally relates to a web-fed printing press, especially to a commercial web press, with at least one printing couple, wherein the printing couple or each printing couple comprises a form cylinder, a transfer cylinder, an inking couple, and preferably a dampening unit. A transfer system is assigned to the transfer cylinder and a printing form system is assigned to the form cylinder, and wherein the transfer system assigned to the transfer cylinder and/or the printing form system assigned to the form cylinder is designed to consist of multiple parts in the axial direction of the respective cylinder in such a way that the transfer system comprises plural rubber sleeves positioned in the axial direction on the transfer cylinder and/or the printing form system comprises plural form sleeves positioned in the axial direction on the form cylinder.

2. Description of the Related Art

In addition to a form cylinder, an inking couple, and possibly a dampening unit, the printing couple of an offset web-fed printing press also comprises a transfer cylinder, where, with the help of the transfer cylinder, ink can be transferred to the substrate to be printed. A transfer system is assigned to the transfer cylinder. A printing form system is assigned to the form cylinder.

In the case of transfer systems, a distinction is made between blanket systems, blanket plate systems, and rubber sleeve systems. In the case of printing form systems, a distinction is made between printing plate systems and form sleeve systems. The present invention is directed to a web-fed printing press with transfer systems designed as rubber sleeve systems and/or to printing form systems designed as form sleeve systems. Rubber sleeves are pushed onto a transfer cylinder in the axial direction, and form sleeves are pushed onto a form cylinder in the axial direction, and therefore neither requires any clamping channels on the cylinder in question, as a result of which endless printing is made possible.

Especially in offset commercial web presses, both rubber sleeve systems and form sleeve systems have been used so far. Each of these systems is adapted to the axial width of the transfer cylinder or form cylinder and extends continuously over the entire axial width of the transfer cylinder or form cylinder actually used for printing.

As the axial width of the transfer cylinder or form cylinder increases, the cost of producing these rubber sleeve systems and form sleeve systems also increases. With increasingly greater axial widths of the rubber sleeve and form sleeve systems, it is virtually impossible to guarantee uniform print quality over the entire axial width used for printing. Due to increasing dimensions and the increasing weight of these rubber sleeve and form sleeve systems, the handling of these systems has become more and more difficult.

In application DE 10 2007 047 781 (US2008/0276814A1), it is proposed that the transfer system assigned to the transfer cylinder and/or the printing form system assigned to the form cylinder be designed with multiple parts in the axial direction of the cylinder in question in such a way that the transfer system comprises plural rubber sleeves positioned next to each other in the axial direction on the transfer cylinder and/or that the printing form system comprises plural form sleeves positioned next to each other in the axial direction on the form cylinder. The transfer cylinder comprises at least two independent compressed air systems and/or the form cylinder comprises at least two independent compressed air systems, which are used to install the sleeves on the cylinder in question and also to remove them.

### SUMMARY OF THE INVENTION

Against this background, it is an object of the present invention to create a novel web-fed printing press.

This object is achieved according to a first aspect of the present invention by a web-fed printing press comprising at least one printing couple, wherein the printing couple or each printing couple comprises a form cylinder, a transfer cylinder, an inking couple, and preferably a dampening unit, wherein a transfer system is assigned to the transfer cylinder and a printing form system is assigned to the form cylinder, and wherein the transfer system assigned to the transfer cylinder and/or the printing form system assigned to the form cylinder is designed to consist of multiple parts in the axial direction of the cylinder in question in such a way that the transfer system comprises plural rubber sleeves positioned in the axial direction on the transfer cylinder and/or the printing form system comprises plural form sleeves positioned in the axial direction on the form cylinder, and wherein the transfer cylinder comprises at least three independent compressed air systems and/or the form cylinder comprises at least three independent compressed air systems to install the sleeves, namely, the rubber sleeves and/or the printing form sleeves, on the cylinder in question, namely, on the transfer cylinder and/or the form cylinder, and also to remove the sleeves from the cylinder. Thus the transfer cylinder comprises at least three independent compressed air systems and/or the form cylinder comprises at least three independent compressed air systems, which are used to install the sleeves, i.e., the rubber sleeves and/or the printing form sleeves, on the cylinder in question, namely, on the transfer cylinder or the form cylinder, and also to remove them.

This object is also achieved according to a second aspect of the present invention by providing a web-fed printing press with at least one printing couple, wherein the printing couple or each printing couple comprises a form cylinder, a transfer cylinder, an inking couple, and preferably a dampening unit, wherein a transfer system is assigned to the transfer cylinder and a printing form system is assigned to the form cylinder, and wherein the transfer system assigned to the transfer cylinder and/or the printing form system assigned to the form cylinder is designed to consist of multiple parts in the axial direction of the cylinder in question in such a way that the transfer system comprises plural rubber sleeves positioned in the axial direction on the transfer cylinder and/or the printing form system comprises plural form sleeves positioned in the axial direction on the form cylinder, and wherein the sleeves, namely, the rubber sleeves and/or the printing form sleeves, comprise an asymmetric division ratio when seen in the axial direction of the cylinder in question, namely, of the transfer cylinder and/or of the form cylinder. Thus the sleeves, namely, the rubber sleeves and/or the printing form sleeves, comprise an asymmetric division ratio, i.e. are divided asymmetrically when seen in the axial direction of the cylinder in question, namely, of the transfer cylinder and/or of the form cylinder.

This object is also achieved according to a third aspect of the present invention by providing a web-fed printing press with at least one printing couple, wherein the printing couple or each printing couple comprises a form cylinder, a transfer cylinder, an inking couple, and preferably a dampening unit, wherein a transfer system is assigned to the transfer cylinder and a printing form system is assigned to the form cylinder, wherein the transfer system assigned to the transfer cylinder and/or the printing form system assigned to the form cylinder is designed to consist of multiple parts in the axial direction of the cylinder in question in such a way that the transfer system comprises plural rubber sleeves positioned in the axial direction on the transfer cylinder and/or the printing form system comprises plural form sleeves positioned in the axial direction on the form cylinder, and wherein the transfer cylinder comprises at least two independent compressed air systems and/or the form cylinder comprises at least two independent compressed air systems to install the sleeves on the cylinder in question and also for removing them from the cylinder, and wherein air bores of a first compressed air system, which open out at the surface of the cylinder in question and are facing the installation-end, are a relatively short distance away from the installation end-facing edge of the installation-end sleeve, and air bores of a second compressed air system, which open out at the surface of the cylinder in question and are facing the stop-end, are a relatively long distance away from the installation end-facing edge of the stop-end sleeve. Thus air bores of a first compressed air system, which open out at the surface of the cylinder in question near the installation-end, are a relatively short distance from installation end-facing edge of the installation-end sleeve, and air bores of a second compressed air system, which open out at the surface of the cylinder in question near the stop-end, are a relatively long distance from the stop-end-facing edge of the stop-end sleeve.

The first aspect of the invention and the second aspect of the invention and the third aspect of the invention can be applied to a web-fed printing press either alone or in combinations of two aspects or even in combination of all three aspects.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

Exemplary embodiments of the invention are explained in greater detail on the basis of the drawing, in which

FIG. 1 is a cross sectional view through a transfer cylinder of a web-fed printing press of the present invention together with a transfer system positioned on the transfer cylinder; and

FIG. 2 shows the transfer cylinder of FIG. 1 as a first part of the transfer system is being mounted onto the same.

### DETAILED DESCRIPTION OF THE PRESENTLY PREFERRED EMBODIMENTS

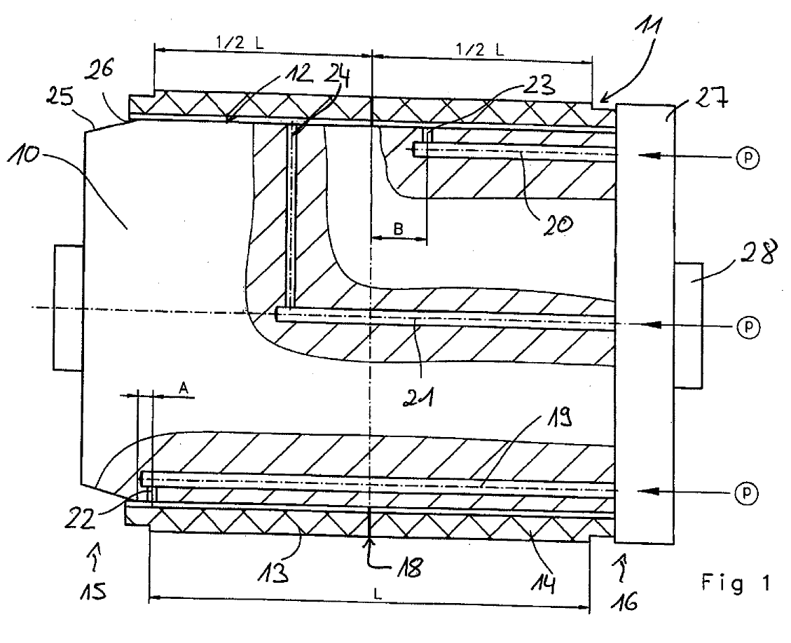

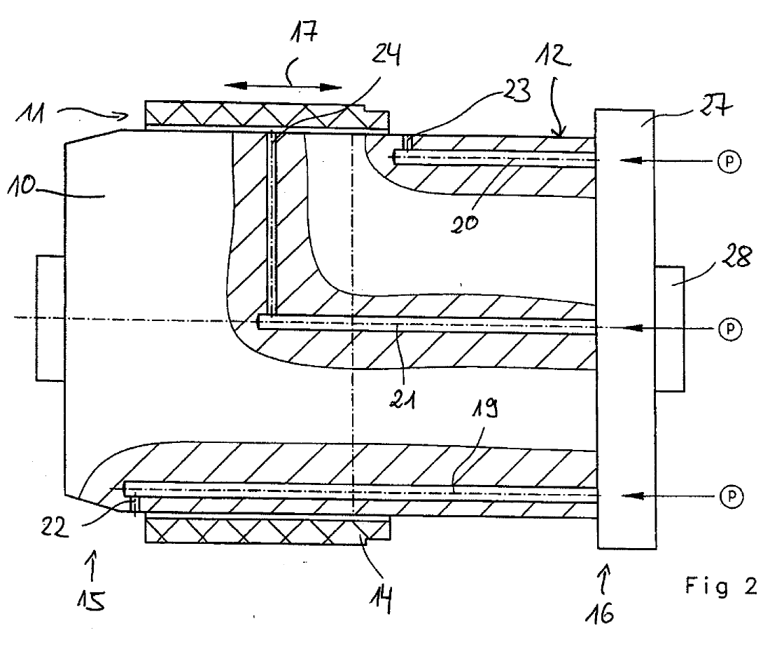

FIGS. 1 and 2 show a transfer cylinder 10 of a printing couple of a web-fed printing press of the present invention, especially a commercial web press, where a transfer system 11, which is mounted on the external surface 12 of the transfer cylinder 10 or is pushed onto this external surface 12, is assigned to the transfer cylinder 10.

In the exemplary embodiment shown in FIGS. 1 and 2, the transfer system 11 comprises two rubber sleeves 13, 14, which are arranged next to each other in the axial direction of the transfer cylinder 10. The rubber sleeve 13 is the sleeve which faces the installation-end 15 of the transfer cylinder 10 and which is therefore called the “installation-end” rubber sleeve, whereas the rubber sleeve 14 faces the stop-end 16 of the transfer cylinder 10 and is therefore called the “stop-end” rubber sleeve. FIG. 1 shows the transfer cylinder 10 in the state which is present after the two rubber sleeves 13, 14 have been pushed onto the external surface 12 of the cylinder. FIG. 2, however, shows the transfer cylinder 10 with only the stop-end rubber sleeve 14. Here, the sleeve is either being pulled onto the surface 12 of the transfer cylinder 10 or pulled from it in the directions indicated by the double arrow 17.

The transfer system 11 shown in FIG. 1 is divided in such a way that a butt joint 18 is present between the directly abutting rubber sleeves 13, 14 in the center of the width L, i.e., the width technically useful for printing, of the transfer cylinder 10, i.e., of the transfer system 11. Each of the rubber sleeves 13, 14 accordingly has a useful printing width of ½ L. The transfer system 11 of FIG. 1 is thus divided symmetrically when seen in the axial direction of the transfer cylinder 10. The butt joint 18 between the two rubber sleeves 13, 14, which are positioned next to each other in the axial direction on the transfer cylinder 10, lies in a non-printing location or in a non-printing axial position of the transfer cylinder 10, in particular in an axial position of a longitudinal fold and/or longitudinal cut to be formed later in the printed substrate.

Although the transfer system 11 in FIGS. 1 and 2 is divided into two parts, it should be noted that the system could also be divided into more than two parts in the axial direction of the transfer cylinder.

A plurality of independent compressed air systems 19, 20, 21 are integrated into the transfer cylinder 10 so that the rubber sleeves 13, 14 of the transfer system 11 can be installed or pushed onto the transfer cylinder 10 and also removed or pulled off the cylinder. Each of these compressed air systems 19, 20, 21 has at least one air opening 22, 23, 24, by which the compressed air system in question opens out to the external surface 12 of the transfer cylinder 10. An air pressure “p” can be made available independently in each of the compressed air systems 19, 20, 21 to build up an air cushion between the surface 12 of the transfer cylinder 10 and the rubber sleeve 13, 14 in question when the sleeves 13, 14 are being installed or pulled on and removed or pulled off.

After the rubber sleeves 13, 14 have been positioned on the transfer cylinder 10, the air bores 22 of the first compressed air system 19, which are in the area of the installation-end 15 of the transfer cylinder, are a relatively short distance A away from the installation end-facing edge of the installation-end rubber sleeve 13. The air bores 23 of the second compressed air system 20, which are in the area of the stop-end 16 of the transfer cylinder 10, are a relatively long distance B away from the installation end-facing edge of the stop-end rubber sleeve 14. As can be seen in FIG. 1, in the installed state of the two rubber sleeves 13, 14, the installation end-facing part of the installation-end rubber sleeve 13 extends by a projection 26 over an installation cone 25 of the transfer cylinder 10, for which reason the area of this projection 26 of the rubber sleeve 13 is no longer supported by the external surface 12 of the transfer cylinder 10.

Because the inside diameter of the rubber sleeve 13 is smaller than the outside diameter of the transfer cylinder 10, the installation-end rubber sleeve 13 therefore shrinks onto the installation cone 25 of the transfer cylinder. The rubber sleeve 13 thus creates an air-tight seal in the area of the installation-end 15, so that an air cushion can be built up over the entire axial length of the rubber sleeve 13 by means of the compressed air system 19. The relatively short distance A between the air openings 22 of the first compressed air system 19 and the installation end-facing edge of the installation-end rubber sleeve 13 is typically on the order of from about 5-10 mm.

Because no seal is possible in the area of the stop-end-facing edge of the stop-end rubber sleeve 14 as there is in the area of the installation end-facing edge of the installation-end rubber sleeve 13, the distance B between the air openings 23 of the compressed air system 20 and the installation end-facing edge of the rubber sleeve 14 is made relatively large to minimize possible leakage losses, where the distance B is on the order of from about 20-30 mm. As a result, it is possible for the installation end-facing part of the rubber sleeve 14 to form a seal against the surface 12 of the transfer cylinder 10, as a result of which leakage losses are avoided and also an air cushion can be built up reliably along the length of the rubber sleeve 14.

To guarantee that the rubber sleeves 13, 14 can be pulled onto and from the surface 12 of the transfer cylinder 10 reliably in the case of a transfer cylinder 10 with a transfer system 11 which is divided symmetrically in the axial direction of the transfer cylinder 10 and which has compressed air systems 19, 20 with air openings 22, 23 at different distances from the installation end-facing edges of the corresponding rubber sleeves 13, 14, a third compressed air system 21 is present in the exemplary embodiment of FIG. 1 in addition to the first compressed air system 19 and the second compressed air system 20. In cases where the sleeves are divided symmetrically, the air opening 24 of the compressed air system 21 is preferably centered in the axial direction between the air openings 22, 23 of the compressed air systems 19, 20.

The air opening 24 or each air opening 24 of the third compressed air system 21 opens out at the surface 12 of the transfer cylinder 10 between the air openings 22, 23 of the compressed air systems 19, 20. Because, in the exemplary embodiment, ½ L<½ L+B−A, it can be guaranteed with the third compressed air system 21 that, no matter what position the rubber sleeve 13 may occupy on the transfer cylinder 10, this sleeve will always cover an air opening 22 or 23 or 24 of at least one of the compressed air systems 19 or 20 or 21. The air bores 22, 23, 24 of the three compressed air systems 19, 20, 21 opening out at the surface of the transfer cylinder 10 are spaced apart from each other in such a way that the axial distance between two adjacent air bores 22, 23, 24 is shorter than the axial dimension of the rubber sleeves.

In the exemplary embodiment of FIGS. 1 and 2 shown, the transfer system 11 of the transfer cylinder 10 is divided symmetrically when seen in the axial direction of the transfer cylinder 10. The two rubber sleeves 13, 14 therefore comprise the same axial dimension of ½ L. In contrast, it is also possible for the transfer system of the transfer cylinder to be divided asymmetrically, such that, therefore, the rubber sleeves comprise different axial dimensions. If, in the exemplary embodiment of FIGS. 1 and 2, the rubber sleeves 13, 14 have different axial dimensions, preferably the stop-end rubber sleeve 14 comprises a larger axial dimension than the installation-end rubber sleeve 13. In this case, it will then be possible to omit the third compressed air system 21, because it can be guaranteed that, regardless of what positions they may occupy, each of the rubber sleeves 13, 14 will cover one of the air openings 22, 23 of the compressed air system 19, 20.

The compressed air is supplied to the compressed air systems 19, 20, 12 through the stop-end of the transfer cylinder, namely, either through the so-called body 27 of the transfer cylinder or through the so-called journal 28 of the transfer cylinder or through both the body 27 and the journal 28 of the transfer cylinder.

The inventive concept is not limited to transfer cylinders or to transfer systems; on the contrary, the invention can also be applied to form cylinders and to printing form systems. The explanations given above apply analogously to printing form systems designed with multiple parts in the axial direction of a form cylinder, where the printing form systems in that case preferably comprise plural form sleeves positioned next to each other in the axial direction.

The invention is not limited by the embodiments described above which are presented as examples only but can be modified in various ways within the scope of protection defined by the appended patent claims.

We claim:

1. A web-fed printing press comprising
at least one printing couple, said printing couple comprising a form cylinder, a transfer cylinder, and an inking couple;
a transfer system assigned to said transfer cylinder and a printing form system assigned to said form cylinder;
at least one of said transfer system comprising plural rubber sleeves positioned in the axial direction on said transfer cylinder and said printing form system comprising plural form sleeves positioned in the axial direction on said form cylinder; and wherein said transfer cylinder (10) comprises at least three independent compressed air systems (19, 20, 21) for installing and removing said rubber sleeves on and from said transfer cylinder and said form cylinder comprises at least three independent compressed air systems for installing and removing said printing form sleeves on and from said form cylinder.

2. The web-fed printing press according to claim 1, wherein said transfer cylinder has a surface and said rubber sleeves have an axial dimension; wherein said at least three compressed air systems (19, 20, 21) additionally comprise air bores (22, 23, 24) opening out at said surface of said transfer cylinder (10); said air bores being spaced apart from each other so that the axial distance between said air bores (22, 23, 24) is shorter than said axial dimension of said rubber sleeves.

3. The web-fed printing press according to claim 1, wherein said form cylinder has a surface and said form sleeves have an axial dimension; and wherein said at least three compressed air systems (19, 20, 21) additionally comprise air bores (22, 23, 24) opening out at said surface of said form cylinder; said air bores being spaced apart from each other so that the axial distance between said air bores is shorter than said axial dimension of said form sleeves.

4. The web-fed printing press according to claim 1, wherein at least one of said transfer system (11) assigned to said transfer cylinder (10) and said the printing form system assigned to said form cylinder is divided into two axial parts so that one of two rubber sleeves (13, 14) and two printing form sleeves are positioned in the axial direction on one of said transfer cylinder and said form cylinder.

5. A web-fed printing press comprising
at least one printing couple, said printing couple comprising a form cylinder, a transfer cylinder, and an inking couple;
a transfer system assigned to said transfer cylinder and a printing form system assigned to said form cylinder;
at least one of said transfer system comprising plural rubber sleeves positioned in the axial direction on said transfer cylinder and said printing form system comprising plural form sleeves positioned in the axial direction on said form cylinder; and
wherein at least one of said rubber sleeves (13, 14) and said printing form sleeves comprise an asymmetric division ratio when seen in the axial direction of a respective one of said transfer cylinder (10) and said form cylinder.

6. The web-fed printing press according to claim 5, wherein said at least one of said transfer cylinder (10) and said form cylinder comprises at least two independent compressed air systems for installing said sleeves on and for removing said sleeves from said respective cylinder.

7. A web-fed printing press comprising
at least one printing couple, said printing couple comprising a form cylinder, a transfer cylinder, and an inking couple;
a transfer system assigned to said transfer cylinder and a printing form system assigned to said form cylinder;
at least one of said transfer system comprising plural rubber sleeves positioned in the axial direction on said transfer cylinder and said printing form system comprising plural form sleeves positioned in the axial direction on said form cylinder; and
one of said transfer cylinder and said form cylinder comprising at least two independent compressed air systems for installing and removing said sleeves on and from the respective cylinder, said printing press having an installation end (15), an edge facing said installation end and a stop end (16); said printing press further comprising an installation-end sleeve (13) for mounting at said installation-end of said press and a stop-end sleeve (14) for mounting at said stop-end of said press;
and wherein a first compressed air system (19) includes air bores (22) which open out at the surface of one of said transfer and form cylinder in an area of said installation-end (15), said air bores (22) being a relatively short distance away from said installation end-facing edge of said installation-end sleeve (13); and wherein a second compressed air system (20) includes further air bores (23), which open out at the surface of one of said transfer and form cylinder in the area of said stop-end (16), said further air bores (23) being a relatively long distance away from said installation end-facing edge of said stop-end sleeve (14).

8. The web-fed printing press according to claim 7, wherein said air bores (22) of said first compressed air system (19) are a distance (A) of from about 5 to about 10 mm from said installation end-facing edge of said installation-end sleeve (13).

9. A web-fed printing press according to claim 7, wherein said further air bores (23) of said second compressed air system (20) are a distance (B) of from about 20 to about 30 mm from said installation end-facing edge of said stop-end sleeve (14).

10. A web-fed printing press according to claim 7, wherein one of said transfer cylinder and form cylinder has an installation cone (25), and wherein said installation end-facing edge of said installation-end sleeve (13, 14) projects over said installation cone (25) of said one of said transfer and form cylinder.
